(19) United States
(12) Patent Application Publication
(10) Pub. No.: US 2026/0369226 A1
(43) Pub. Date: Nov. 19, 2026

(54) DISPLAY PANEL AND DISPLAY APPARATUS

(71) Applicant: Xiamen Tianma Display Technology Co., Ltd., Xiamen (CN)

(72) Inventors: Hanqiang ZHOU, Xiamen (CN); Jian LIU, Xiamen (CN); Yana GAO, Xiamen (CN); Yuheng ZHANG, Xiamen (CN)

(21) Appl. No.: 19/437,210

(22) Filed: Dec. 30, 2025

(30) Foreign Application Priority Data
Jan. 6, 2025 (CN) 202510018195.0

(51) Int. Cl. G09G 3/3233

(52) U.S. Cl. CPC G09G 3/3233; G09G 2300/0819; G09G 2300/0842; G09G 2310/0245; G09G 2310/08; G09G 2320/0223; G09G 2320/0247; G09G 2320/045; G09G 2330/021

(57) ABSTRACT

Provided are a display panel and a display apparatus. A picture display process of the display panel includes a current frame and a first frame to be displayed. Display time of the current frame is earlier than that of the first frame to be displayed. When refresh rates of the current frame and the first frame to be displayed are not equal and are both less than a preset low-frequency refresh rate, the process further includes an inserted frame, display time of the inserted frame is between the display time of the current frame and the display time of the first frame to be displayed, and a refresh rate of the inserted frame is greater than or equal to a preset high-frequency refresh rate, which is greater than the preset low-frequency refresh rate.

### CROSS-REFERENCE TO RELATED APPLICATION

The present application claims priority to Chinese Application No. 202510018195.0 filed on Jan. 06, 2025, the content of which is incorporated herein by reference in its entirety.

### Technical Field

The embodiments of the present disclosure relate to the field of display technologies, and in particular, to a display panel and a display apparatus.

### Background

With the advancement and development of display technologies, the requirements for the visual effect and picture quality of display panels have gradually increased. During a display process in which a refresh rate of a display panel is directly switched from a high frequency to a low frequency, the device state of a driving transistor changes significantly, causing the driving transistor to be in a negative bias state when displaying a low-frequency first frame. As a result, the display brightness of the low-frequency first frame of picture is caused to decrease, and the display brightness gradually recovers in a low-frequency second frame of picture, which leads to a difference between the display brightness of the low-frequency first frame of a display picture and the steady-state brightness of the display picture, affecting the stability of the display picture and causing the problem of screen flickering.

### SUMMARY

Based on the above, embodiments of the present disclosure provide a display panel and a display apparatus, which can improve the compensation accuracy of the display brightness of the low-frequency first frame of a display picture under different frequency-switching scenarios, enhance the compensation effect, suppress the screen flickering phenomenon in the frequency-switching process of the display picture, improve the stability of the display picture, and improve the display effect and display quality of the display panel.

In a first aspect of the embodiments of the present disclosure, there is provided a display panel, where a picture display process of the display panel includes a current frame and a first frame to be displayed, where display time of the current frame is earlier than display time of the first frame to be displayed, a refresh rate of the current frame is a first refresh rate, and a refresh rate of the first frame to be displayed is a second refresh rate;
in a case where the first refresh rate and the second refresh rate are not equal and both the first refresh rate and the second refresh rate are less than a preset low-frequency refresh rate, the picture display process of the display panel further includes an inserted frame, display time of the inserted frame is between the display time of the current frame and the display time of the first frame to be displayed, and a refresh rate of the inserted frame is greater than or equal to a preset high-frequency refresh rate; and
where the preset high-frequency refresh rate is greater than the preset low-frequency refresh rate.

In a second aspect of the embodiments of the present disclosure, there is provided a display panel including a display driving chip and a pixel circuit;
where the display driving chip is used to provide a driving signal to the pixel circuit and is configured to:
obtain a first refresh rate at which the display panel displays a current frame and a second refresh rate at which the display panel displays the first frame to be displayed, where display time of the current frame is earlier than display time of the first frame to be displayed; and
provide, in a case where the first refresh rate and the second refresh rate are not equal and both the first refresh rate and the second refresh rate are less than a preset low-frequency refresh rate, the driving signal to the pixel circuit, so that the pixel circuit drives a display picture to display an inserted frame according to the driving signal, where display time of the inserted frame is between the display time of the current frame and the display time of the first frame to be displayed, and a refresh rate of the inserted frame is greater than or equal to a preset high-frequency refresh rate.

In a third aspect of the embodiments of the present disclosure, there is provided a display apparatus including the display panel as described above in the first aspect.

### BRIEF DESCRIPTION OF DRAWINGS

In order to more clearly illustrate the technical solutions in the embodiments of the present disclosure or in the related technologies, the accompanying drawings required to be used in the description of the embodiments of the present disclosure or the related technologies will be briefly introduced. Apparently, the accompanying drawings in the following description are only some embodiments of the present disclosure. For those of ordinary skill in the art, other relevant accompanying drawings can also be obtained from these drawings without any creative efforts.

FIG. 1 is a schematic timing diagram of a display panel provided by an embodiment of the present disclosure.

FIG. 2 is a brightness data diagram before the improvement of a first frame for a related display panel provided by an embodiment of the present disclosure.

FIG. 3 is a schematic timing diagram of a related display panel provided by an embodiment of the present disclosure.

FIG. 4 is a brightness data diagram after the improvement of a first frame for a related display panel provided by an embodiment of the present disclosure.

FIG. 5 is a brightness data diagram showing an overcompensation phenomenon that occurs after the improvement of a first frame for a related display panel provided by an embodiment of the present disclosure.

FIG. 6 is a schematic timing diagram of another display panel provided by an embodiment of the present disclosure.

FIG. 7 is a schematic timing diagram of yet another display panel provided by an embodiment of the present disclosure.

FIG. 8 is a schematic timing diagram of a further display panel provided by an embodiment of the present disclosure.

FIG. 9 is a schematic timing diagram of a display panel provided by an embodiment of the present disclosure.

FIG. 10 is a schematic timing diagram of another display panel provided by an embodiment of the present disclosure.

FIG. 11 is a schematic structural diagram of a display panel provided by an embodiment of the present disclosure.

FIG. 12 is a schematic structural diagram of a pixel circuit of a display panel provided by an embodiment of the present disclosure.

FIG. 13 is a schematic structural diagram of a display apparatus provided by an embodiment of the present disclosure.

### REFERENCE SIGNS

100 - Display driving chip; 200 - Pixel circuit; 1000 - Display panel.

### DESCRIPTION OF EMBODIMENTS

To facilitate the understanding of the present disclosure, the present disclosure will be described more comprehensively below with reference to the relevant accompanying drawings. Embodiments of the present disclosure are shown in the accompanying drawings. However, the present disclosure can be implemented in many different forms and is not limited to the embodiments described herein. Rather, the purpose of providing these embodiments is to make the disclosure of the present disclosure more thorough and comprehensive.

Unless otherwise specified, all technical and scientific terms used herein have the same meaning as commonly understood by those skilled in the art to which the present disclosure belongs. The terms used in the specification of the present disclosure herein are only for the purpose of describing specific embodiments and are not intended to limit the present disclosure.

It should be understood that when an element or layer is referred to as being “on”, “adjacent to”, “connected to”, or “coupled to” another element or layer, it can be directly on, adjacent to, connected or coupled to the other element or layer, or there may be intermediate elements or layers. In contrast, when an element is referred to as being “directly on”, “directly adjacent to”, “directly connected to”, or “directly coupled to” another element or layer, there are no intermediate elements or layers. It should be understood that although the terms “first”, “second”, “third”, etc. may be used to describe various elements, components, regions, layers, doping types, and/or portions, these elements, components, regions, layers, doping types, and/or portions should not be limited by these terms. These terms are only used to distinguish one element, component, region, layer, doping type, or portion from another. Therefore, without departing from the teaching of the present disclosure, a first element, component, region, layer, doping type, or portion discussed below may be referred to as a second element, component, region, layer, or portion. For example, a first doping type may be referred to as a second doping type, and similarly, the second doping type may be referred to as the first doping type. The first doping type and the second doping type are different doping types, for instance, the first doping type may be P-type and the second doping type may be N-type, or the first doping type may be N-type and the second doping type may be P-type.

Spatial relationship terms such as “under”, “below”, “beneath”, “underneath”, “above”, “over”, etc. may be used herein to describe the relationship of one element or feature and other elements or features shown in the drawings. It should be understood that the spatial relationship terms include different orientations of a device in use and operation, in addition to the orientation shown in the drawings. For example, if a device in the drawings is flipped over, an element or feature described as “below”, “beneath” or “under” other elements or features will be oriented to be “above” the other elements or features. Thus, the exemplary terms “below” and “under” can include both upper and lower orientations. In addition, the device may also be otherwise oriented (e.g., rotated 90 degrees or at other orientations), and the spatial descriptors used herein are interpreted accordingly.

As used herein, the singular forms “a”, “an” and “the” can also include the plural forms, unless the context clearly indicates otherwise. It should also be understood that the terms “comprise/include” or “have” etc. specify the presence of the stated features, integers, steps, operations, components, parts, or combinations thereof, but do not preclude the possibility of the presence or addition of one or more other features, integers, steps, operations, components, parts, or combinations thereof. Meanwhile, in the present specification, the term “and/or” includes any and all combinations of the associated listed items.

It should be noted that with the advancement and development of display technologies, the requirements for the visual effect and picture quality of display panels have gradually increased. During a display process in which a refresh rate of a display panel is directly switched from a high frequency to a low frequency, the device state of a driving transistor changes significantly, causing the driving transistor to be in a negative bias state when displaying a low-frequency first frame. As a result, the display brightness of the low-frequency first frame of picture is caused to decrease, and the display brightness gradually recovers in a low-frequency second frame of picture, which leads to a difference between the display brightness of the low-frequency first frame of a display picture and the steady-state brightness of the display picture, affecting the stability of the display picture and causing the problem of screen flickering.

In a traditional display panel, a bias voltage signal and a reference voltage signal of the low-frequency first frame of picture are generally changed to compensate for the display brightness of the low-frequency first frame of the display picture, reducing the brightness difference between the display brightness of the low-frequency first frame of the display picture and the steady-state brightness of the display picture, thereby improving the stability of the display picture.

However, the traditional display panel generally uses the same preset compensation value in the frequency-switching process of different amplitudes, and the preset compensation value is generally determined according to the maximum and minimum values of the refresh rate of the display panel. Therefore, when the difference in refresh rate between the two frames of pictures before and after the frequency-switching of the display panel is smaller, using the preset compensation value for brightness compensation will cause an overcompensation phenomenon in the low-frequency first frame of picture after the frequency-switching, which causes the display brightness of the low-frequency first frame of the display picture to be greater than the steady-state brightness, further exacerbating the screen flickering problem of the display picture, affecting the stability of the display picture, and affecting the display effect and display quality of the display panel. Adjusting the compensation signal according to the difference in refresh rate between the two frames before and after the frequency-switching will increase the computing power required for the frequency-switching of the display panel, which in turn leads to an increase in the power consumption of the display panel.

In view of the above, providing a display panel that can improve the stability of mutual switching between low-frequency pictures and reduce the difficulty of display picture brightness compensation is an urgent technical problem to be solved at present.

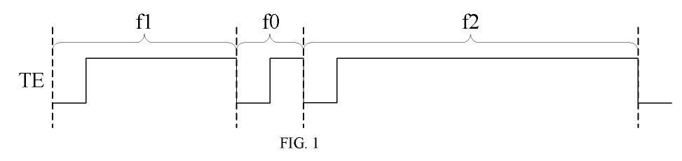

FIG. 1 is a schematic timing diagram of a display panel provided by an embodiment of the present disclosure. As shown in FIG. 1 , in a first aspect of the embodiments of the present disclosure, the display panel is provided. A picture display process of the display panel includes a current frame f1 and a first frame f2 to be displayed, and display time of the current frame f1 is earlier than display time of the first frame f2 to be displayed. A refresh rate of the current frame f1 is a first refresh rate, and a refresh rate of the first frame f2 to be displayed is a second refresh rate. In the case where the first refresh rate and the second refresh rate are not equal and both the first refresh rate and the second refresh rate are less than a preset low-frequency refresh rate, the picture display process of the display panel further includes an inserted frame f0. Display time of the inserted frame f0 is between the display time of the current frame f1 and the display time of the first frame f2 to be displayed, and a refresh rate of the inserted frame f0 is greater than or equal to a preset high-frequency refresh rate, which is greater than the preset low-frequency refresh rate.

It should be noted that a tearing effect (TE) signal in FIG. 1 can prevent the tearing problem when the picture is refreshed in the picture display process. At a rising edge of the TE signal or upon detecting that the TE signal is in a high-level state, the next frame of picture data can be sent to a display driving chip to drive the display of the next frame of display picture. Therefore, an interval of the TE signal represented by dotted lines in the illustration of the present disclosure represents a display period of one frame of display picture. A larger display period indicates a lower refresh rate of the frame of picture, and conversely, a smaller display period indicates a higher refresh rate of the frame of picture.

Exemplarily, the preset low-frequency refresh rate and the preset high-frequency refresh rate can be determined according to switchable refresh rates of the display panel. For example, for a display panel with switchable refresh rates of 480Hz or higher, 120Hz, 60Hz, 20Hz, 10Hz, and 1Hz, the preset low-frequency refresh rate can be 60Hz, and the preset high-frequency refresh rate can be 120Hz, 480Hz or higher. For a display panel with switchable refresh rates of 480Hz or higher, 120Hz, 90Hz, 60Hz, 20Hz, and 10Hz, the preset low-frequency refresh rate can be 60Hz, and the preset high-frequency refresh rate can be 90Hz, 480Hz or higher.

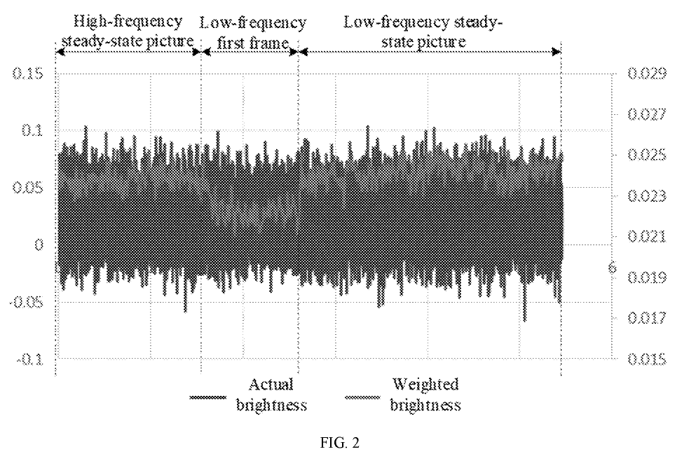

FIG. 2 is a brightness data diagram before the improvement of a first frame for a related display panel provided by an embodiment of the present disclosure. As shown in FIG. 2, the blue curve in the data graph represents the actual brightness of a display picture, and the red curve represents the weighted brightness of the display picture obtained by performing weighted fitting filtering and other processing on the actual brightness. The left vertical axis of the data graph represents the value of the actual brightness of the display picture in nits, and the right vertical axis of the data graph represents the value of the weighted brightness of the display picture in nits. It can be seen from FIG. 2 that in the related display panel, in the case where the display picture is directly switched from a high frequency to a low frequency, after the display of a high-frequency picture in a steady state is completed, a low-frequency picture will first display a low-frequency first frame of picture with a brightness lower than a steady-state brightness of the display picture, and at the beginning of a second frame of the low-frequency picture, the display brightness reaches the steady-state brightness.

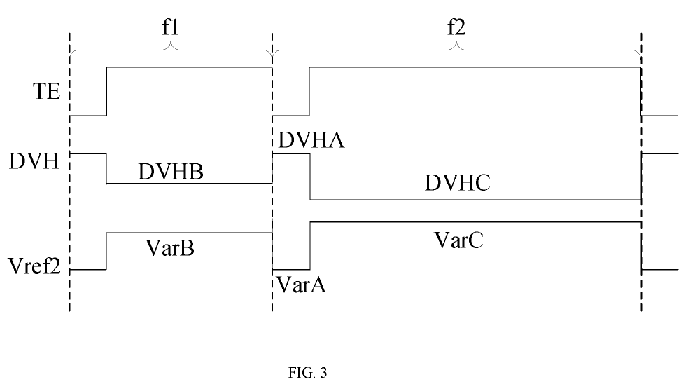

FIG. 3 is a schematic timing diagram of a related display panel provided by an embodiment of the present disclosure. As shown in FIG. 3 , in the related display panel, for the current frame f1 and the first frame f2 to be displayed for which the first refresh rate and the second refresh rate are not equal and both the first refresh rate and the second refresh rate are less than the preset low-frequency refresh rate, a preset compensation signal is generally configured to compensate the first frame f2 to be displayed. Here, DVH represents a bias voltage signal of a display picture, DVHA represents the bias voltage signal of the display picture at a non-display stage or the bias voltage signal corresponding to the display picture at a high-frequency refresh rate, DVHB represents the bias voltage signal corresponding to the display picture at a low-frequency refresh rate, and DVHC represents the bias voltage signal corresponding to the display picture when the refresh rate is switched. Vref2 represents a reference voltage signal of the display picture, VarA represents the reference voltage signal of the display picture at the non-display stage or the reference voltage signal corresponding to the display picture at the high-frequency refresh rate, VarB represents the reference voltage signal corresponding to the display picture at the low-frequency refresh rate, and VarC represents the reference voltage signal corresponding to the display picture when the refresh rate is switched. It should be noted that DVHC and VarC are preset for compensating, when the display picture is directly switched from the high-frequency refresh rate to the low-frequency refresh rate, a first frame of display picture corresponding to the low-frequency refresh rate, to reduce the brightness difference between a first frame of low-frequency display picture and the low-frequency display picture in the steady state.

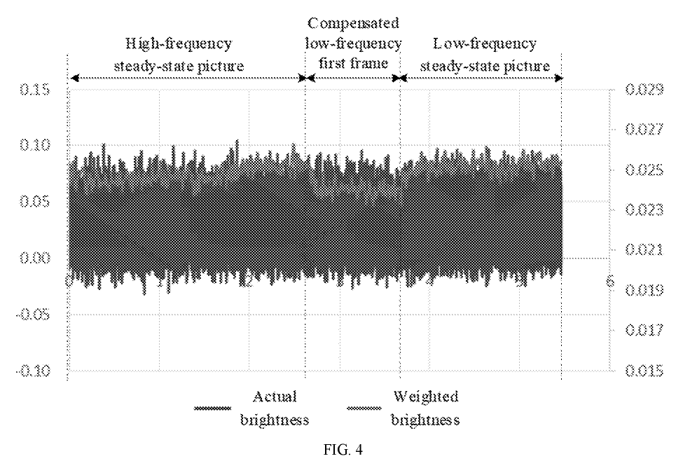

FIG. 4 is a brightness data diagram after the improvement of a first frame for a related display panel provided by an embodiment of the present disclosure. As shown in FIG. 4, in the related display panel, the blue curve in the data graph represents the actual brightness of a display picture, and the red curve represents the weighted brightness of the display picture obtained by performing weighted fitting filtering and other processing on the actual brightness. The left vertical axis represents the value of the actual brightness of the display picture in nits, and the right vertical axis represents the value of the weighted brightness of the display picture in nits. It can be seen from FIG. 4 that in the related display panel, in the case where the display picture is directly switched from a high frequency to a low frequency, after the display of a high-frequency picture in a steady state is completed, a preset compensation signal is applied to a low-frequency first frame of picture to compensate the low-frequency first frame of picture, which can make the brightness of the compensated low-frequency first frame of picture close to the steady-state brightness of the low-frequency display picture, and can reduce the brightness difference between the low-frequency first frame of picture and the steady-state brightness.

It should be noted that since the compensation signals DVHC and VarC are set according to the application scenario of the display picture being directly switched from a high frequency to a low frequency, in the case where the current frame f1 with low-frequency is switched to the first frame f2 to be displayed with low frequency, using the same compensation signals will lead to overcompensation of the first frame f2 to be displayed, causing the brightness of the first frame f2 to be displayed to be greater than the brightness of the display picture with the same refresh rate in a steady state, and further exacerbating the flickering problem of the display picture.

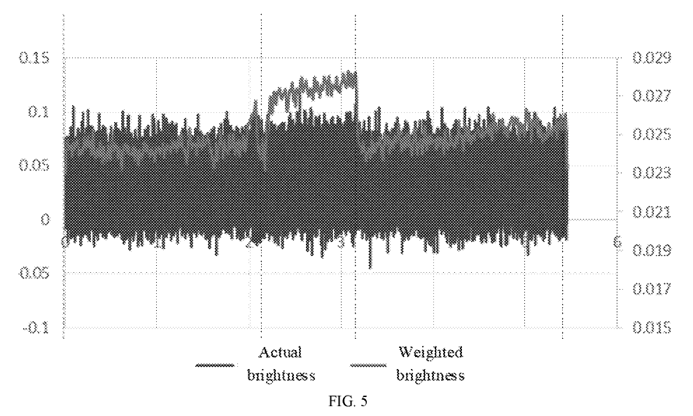

FIG. 5 is a brightness data diagram showing an overcompensation phenomenon that occurs after the improvement of a first frame for a related display panel provided by an embodiment of the present disclosure. As shown in FIG. 5, in the related display panel, the blue curve in the data graph represents the actual brightness of a display picture, and the red curve represents the weighted brightness of the display picture obtained by performing weighted fitting filtering and other processing on the actual brightness. The left vertical axis represents the value of the actual brightness of the display picture in nits, and the right vertical axis represents the value of the weighted brightness of the display picture in nits. It can be seen from FIG. 5 that in the related display panel, in the case where the display picture is switched from a first low frequency to a second low frequency, after the display of a first low-frequency steady-state picture in a steady state is completed, the same preset compensation signal as that for the direct switching from the high frequency to the low frequency is applied to a first frame of picture of the second low frequency to compensate the first frame of picture of the second low frequency, which may overcompensate the brightness of the first frame of picture of the second low frequency, so that the brightness of the first frame of picture of the second low frequency is higher than the steady-state brightness of the display picture, further increasing the brightness difference between the brightness of the first frame of picture of the second low frequency and the steady-state brightness.

In the display panel provided by the embodiments of the present disclosure, in the case where the first refresh rate of the current frame f1 is not equal to the second refresh rate of the first frame f2 to be displayed and both the first refresh rate and the second refresh rate are less than the preset low-frequency refresh rate, the inserted frame f0 with the refresh rate greater than or equal to the preset high-frequency refresh rate is inserted between the current frame f1 and the first frame f2 to be displayed, where the preset high-frequency refresh rate is greater than the preset low-frequency refresh rate. By inserting a high-frequency inserted frame f0 between two frames of low-frequency pictures that need to be mutually switched, the difference in refresh rate between the first frame f2 to be displayed and the inserted frame f0 serving as a previous frame can be increased, which can further cause the difference in refresh rate between the first frame f2 to be displayed and the inserted frame f0 to be close to the preset difference in refresh rate corresponding to the preset compensation value for the low-frequency first frame of the display panel. Therefore, when using the same compensation signal for brightness compensation in the mutual switching of display pictures with different refresh rates, it can be avoided that the compensation signal for switching directly from a high frequency to a low frequency is used in the low-frequency mutual switching process, reducing the risk of overcompensation in the brightness compensation process, avoiding the picture of the first frame to be displayed after switching from flickering, improving the stability of the display picture, and improving the display effect and display quality of the display panel.

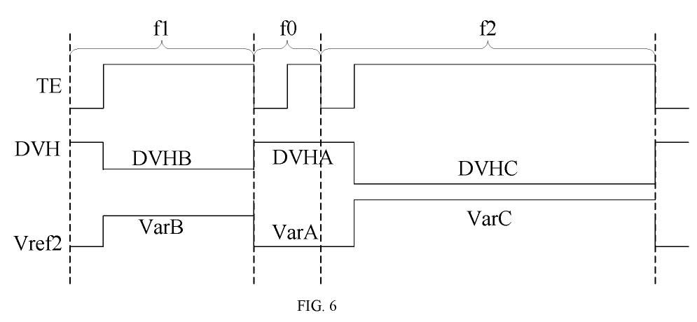

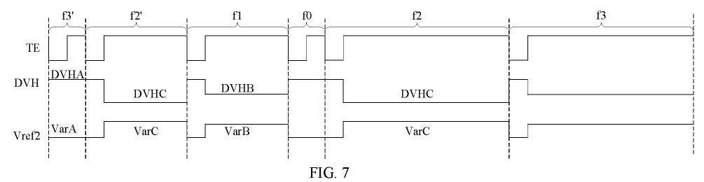

As shown in FIGS. 1, 6, and 7, in some implementations, there is one inserted frame f0. FIG. 6 is a schematic timing diagram of another display panel provided by an embodiment of the present disclosure, and FIG. 7 is a schematic timing diagram of yet another display panel provided by an embodiment of the present disclosure.

It should be noted that, as shown in FIG. 7, before the display time of the current frame f1, the display picture also includes a high-frequency frame f3’ and a previous frame f2’, where the refresh rate of the high-frequency frame f3’ is greater than the preset high-frequency refresh rate, and the refresh rate of the previous frame f2’ is equal to the first refresh rate. After the display time of the first frame f2 to be displayed, the display picture also includes a next frame f3, where the refresh rate of the next frame f3 is equal to the second refresh rate.

In the display picture switching process shown in FIG. 7 , when the display picture is switched from the high-frequency frame f3’ to the previous frame f2’, the difference in refresh rate between the two frames of pictures is larger, and brightness compensation can be performed through DVHC and VarC without causing the overcompensation problem. After the display of the previous frame f2’ is completed, when the display picture is switched from the previous frame f2’ to the current frame f1, the display of the current frame f1 is adjusted to the standard steady-state display through DVHB and VarB. In the case where the inserted frame f0 is set, when the display picture is switched from the current frame f1 to the inserted frame f0, driving can be performed through DVHA and VarA, and no compensation is performed for the inserted frame f0. When the display picture is switched from the inserted frame f0 to the first frame f2 to be displayed, the difference in refresh rate between the two frames of pictures is larger, and brightness compensation can be performed again through DVHC and VarC. After the display of the first frame f2 to be displayed is completed, when the display picture is switched from the first frame f2 to be displayed to the next frame f3, the display of the next frame f3 is adjusted to the standard steady-state display through DVHB and VarB.

The embodiments of the present disclosure provide a display panel and a display apparatus, in which by inserting a high-frequency inserted frame f0 between two frames of low-frequency pictures that need to be mutually switched, the display time of the inserted frame f0 can be further shortened, the power consumption required for the display of the high-frequency inserted frame f0 can be reduced, the display effect of the display picture can be further improved, and the display performance of the display panel can be improved.

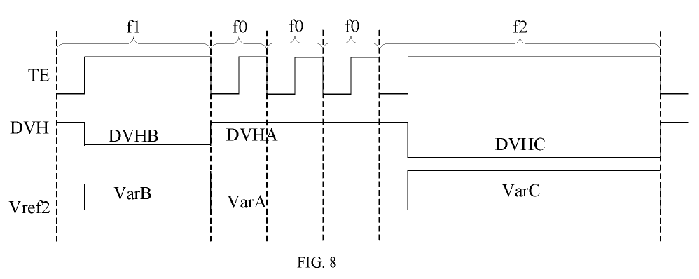

FIG. 8 is a schematic timing diagram of a further display panel provided by an embodiment of the present disclosure. As shown in FIG. 8, in some implementations, there are a plurality of inserted frames f0.

It should be noted that the number of the inserted frames f0 can be three. The longer the display time of the inserted frames f0, the greater the display power consumption of the display panel. Therefore, it is necessary to reduce the number of the inserted frames f0. Since the refresh rates of the inserted frames f0 are higher, when the plurality of inserted frames f0 are inserted, the total display time of all the inserted frames f0 is still shorter, and the impact on the display effect of the display picture is smaller. Therefore, the plurality of inserted frames f0 can be inserted between the current frame f1 and the first frame f2 to be displayed.

In the display panel provided by the embodiments of the present disclosure, by increasing the number of the inserted frames f0, the display transition between the current frame f1 and the inserted frames f0 can be realized, and the problem of unstable display picture caused when the low-frequency current frame f1 is switched to the high-frequency inserted frames f0 can be avoided. Therefore, the display stability of the inserted frames f0 can be improved, making it possible to display the first frame f2 to be displayed after the picture of the inserted frames f0 becomes stable. The brightness uniformity and stability of the display panel can be further improved, the flickering risk of the display picture can be reduced, and the display effect and display quality of the display panel can be improved.

In some implementations, the refresh rates of at least two of the inserted frames f0 are equal.

Exemplarily, the refresh rates of all the inserted frames f0 between the current frame f1 and the first frame f2 to be displayed can be equal. For example, for a display panel with switchable refresh rates of 480Hz or higher, 120Hz, 60Hz, 20Hz, 10Hz, and 1Hz, the refresh rates of the inserted frames f0 can be 120Hz, 480Hz or higher, and the refresh rates of all the inserted frames f0 are equal.

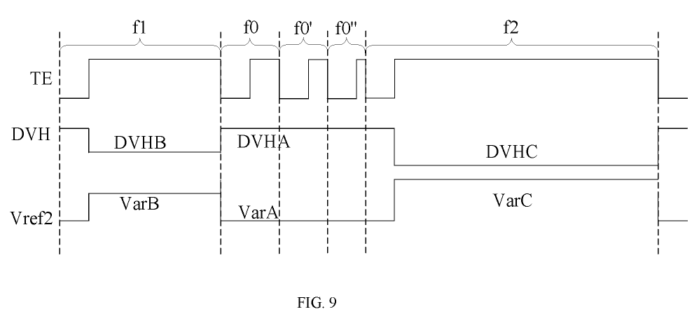

FIG. 9 is a schematic timing diagram of a display panel provided by an embodiment of the present disclosure. Exemplarily, as shown in FIG. 9, the refresh rates of the inserted frames f0 between the current frame f1 and the first frame f2 to be displayed can increase in a stepwise manner. As shown in FIG. 9, an inserted frame f0, an inserted frame f0’, and an inserted frame f0’’ are provided between the current frame f1 and the first frame f2 to be displayed. Here, the refresh rate of the inserted frame f0’’ is greater than the refresh rate of the inserted frame f0’, and the refresh rate of the inserted frame f0’ is greater than the refresh rate of the inserted frame f0. For example, for a display panel with switchable refresh rates of 480Hz or higher, 120Hz, 60Hz, 20Hz, 10Hz, and 1Hz, the refresh rates of the inserted frames f0 can be 90Hz, 120Hz, 480Hz or higher in sequence.

In the display panel provided by the embodiments of the present disclosure, by setting the refresh rates of the at least two of the inserted frames f0 between the current frame f1 and the first frame f2 to be displayed to be equal, the adjustment frequency of the inserted frames f0 can be reduced, the driving complexity and control difficulty of the inserted frames f0 can be reduced, and the brightness uniformity and stability of the display panel can be further improved. Meanwhile, the overcompensation of the brightness of display picture caused by different refresh rates of the inserted frames f0 can be avoided, the flickering risk of the display picture can be reduced, and the display effect and display quality of the display panel can be improved.

In some implementations, the inserted frame f0 is periodically inserted between the current frame f1 and the first frame f2 to be displayed.

Exemplarily, as shown in FIG. 8 , the plurality of inserted frames f0 with the same refresh rate can be continuously inserted between the current frame f1 and the first frame f2 to be displayed. Here, the insertion period of the inserted frame f0 is the display period of the inserted frame f0. For example, in the case where the refresh rate of the inserted frame f0 is 120Hz, the display period of the inserted frame f0 includes a non-display stage and a display stage. Here, the non-display stage is used to receive a driving signal, and the display stage is used to drive a light-emitting element to emit light. A different refresh rate of the inserted frame f0 generally means a different duration required for the display stage in the display period, while the duration required for the non-display stage generally does not change with the refresh rate, and the duration required for the non-display stage of the same display panel is generally fixed. According to the content shown in FIG. 8 , in the inserted frame f0, the non-display stage corresponds to the low-level stage of the TE signal, and the display stage corresponds to the high-level stage of the TE signal.

Exemplarily, the display periods of the inserted frames f0 can be not equal, so that the refresh rates of the inserted frames f0 are not equal. For example, in the case where a plurality of inserted frames f0 are periodically inserted between the current frame f1 and the first frame f2 to be displayed and the display periods of the inserted frames f0 are not equal, for a display panel with switchable refresh rates of 480Hz or higher, 120Hz, 60Hz, 20Hz, 10Hz, and 1Hz, the refresh rates of the inserted frames f0 provided at intervals can be equal. For instance, the refresh rates of the plurality of inserted frames f0 are alternately provided at 120Hz, 480Hz or higher. For a display panel with switchable refresh rates of 480Hz or higher, 120Hz, 90Hz, 60Hz, 20Hz, and 10Hz, the refresh rates of the inserted frames f0 provided at intervals can be equal. For example, the refresh rates of the plurality of inserted frames f0 are cyclically provided at 90Hz, 120Hz, 480Hz or higher. For example, in the case where the plurality of inserted frames f0 are periodically inserted between the current frame f1 and the first frame f2 to be displayed and the display periods of the inserted frames f0 are not equal, for a display panel with switchable refresh rates of 480Hz or higher, 120Hz, 60Hz, 20Hz, 10Hz, and 1Hz, the refresh rates of the plurality of inserted frames f0 are provided in a stepwise increasing manner from 120Hz to 480Hz or higher. For a display panel with switchable refresh rates of 480Hz or higher, 120Hz, 90Hz, 60Hz, 20Hz, and 10Hz, the refresh rates of the plurality of inserted frames f0 are provided in a stepwise increasing manner from 90Hz, 120Hz to 480Hz or higher.

In the display panel provided by the embodiments of the present disclosure, by periodically inserting the inserted frame f0, the continuity and fluency of the display picture can be improved. Thus, the stability of the display picture can be improved, and the display effect and display performance of the display panel can be further improved.

In some implementations, the refresh rate of the inserted frame f0 is greater than or equal to 90Hz.

Exemplarily, for a display panel with switchable refresh rates of 480Hz or higher, 120Hz, 60Hz, 20Hz, 10Hz, and 1Hz, the refresh rate of the inserted frame f0 can be 120Hz, 480Hz or higher. For a display panel with switchable refresh rates of 480Hz or higher, 120Hz, 90Hz, 60Hz, 20Hz, and 10Hz, the refresh rate of the inserted frame f0 can be 90Hz, 120Hz, 480Hz or higher. For a display panel with switchable refresh rates of 90Hz, 60Hz, 20Hz, 10Hz, and 1Hz, the refresh rate of the inserted frame f0 can be 90Hz.

In the display panel provided by the embodiments of the present disclosure, by setting the refresh rate of the inserted frame f0 to be greater than or equal to 90Hz, the difference in refresh rate between the first frame f2 to be displayed and the inserted frame f0 serving as a previous frame can be increased, which can further cause the difference in refresh rate between the first frame f2 to be displayed and the inserted frame f0 to be close to the preset difference in refresh rate corresponding to the preset compensation value for the low-frequency first frame of the display panel. Therefore, when using the same compensation signal for brightness compensation in the mutual switching of display pictures with different refresh rates, it can be avoided that the compensation signal for switching directly from a high frequency to a low frequency is used in the low-frequency mutual switching process, reducing the risk of overcompensation in the brightness compensation process, avoiding the picture of the first frame to be displayed after switching from flickering, improving the stability of the display picture, and improving the display effect and display quality of the display panel.

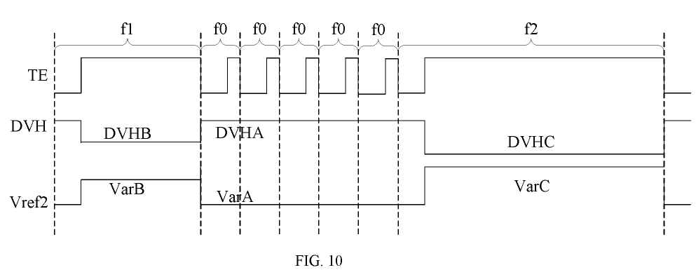

FIG. 10 is a schematic timing diagram of another display panel provided by an embodiment of the present disclosure. As shown in FIGS. 8 and 10, in some implementations, the number of the inserted frames f0 is negatively correlated with the refresh rate of the inserted frames f0. According to what is shown in FIGS. 8 and 10, the refresh rate of the inserted frames f0 in the case where the number of the inserted frames f0 is 5 is less than the refresh rate of the inserted frames f0 in the case where the number of the inserted frames f0 is 3.

Exemplarily, in the case where the number of the inserted frames f0 is 5, the refresh rate of the inserted frames f0 can be 90Hz. In the case where the number of the inserted frames f0 is 3, the refresh rate of the inserted frames f0 can be 120Hz. In the case where the number of the inserted frames f0 is 1, the refresh rate of the inserted frame f0 can be 480Hz or higher.

It should be noted that the greater the refresh rate of the inserted frames f0, the higher the power consumption required for the display of the inserted frames f0. Therefore, by setting the negative correlation between the number of the inserted frames f0 and the refresh rate of the inserted frames f0, it is convenient to control the number of the inserted frames f0, which can reduce the driving difficulty of the inserted frames f0, further reduce the display power consumption of the display panel, improve the stability of the display picture, and further improve the display effect and display quality of the display panel.

In some implementations, the frequency difference between the first refresh rate and the second refresh rate is a first frequency difference, where the first frequency difference is less than or equal to a preset frequency difference threshold.

Exemplarily, the preset frequency difference threshold can be determined according to the switchable refresh rates of the display panel. For example, for a display panel with switchable refresh rates of 480Hz or higher, 120Hz, 60Hz, 20Hz, 10Hz, and 1Hz, the preset frequency difference threshold can be 9Hz to 59Hz. For a display panel with switchable refresh rates of 480Hz or higher, 120Hz, 90Hz, 60Hz, 20Hz, and 10Hz, the preset frequency difference threshold can be 10Hz to 50Hz.

It should be noted that in the case where the first frequency difference is less than or equal to the preset frequency difference threshold, the use of the preset compensation signal when switching between the current frame f1 and the first frame f2 to be displayed will exacerbate the problem of brightness overcompensation of the display picture.

In the display panel provided by the embodiments of the present disclosure, by setting the first frequency difference to be less than or equal to the preset frequency difference threshold, in the case where the refresh rates of the current frame f1 and the first frame f2 to be displayed are close, an inserted frame f0 can be provided between the current frame f1 and the first frame f2 to be displayed, which can further improve the brightness uniformity and stability when switching between low-frequency display pictures close to the first frequency difference, reduce the flickering risk of the first frame f2 to be displayed after switching, and improve the display effect and display quality of the display panel.

In some implementations, the display panel further includes a display driving chip, where the display driving chip is configured to provide a compensation signal to a pixel circuit in the case where the refresh rate of the inserted frame f0 is not equal to the second refresh rate of the first frame f2 to be displayed, to cause the pixel circuit to drive the display picture to display the first frame f2 to be displayed according to compensation signal.

In the display panel provided by the embodiments of the present disclosure, in the case where the first refresh rate of the current frame f1 and the second refresh rate of the first frame f2 to be displayed are not equal, by providing the compensation signal by the display driving chip to the pixel circuit, the display brightness of the first frame after switching can be compensated in the process of mutual switching of display pictures with different refresh rates, thereby improving the brightness uniformity and stability of the display picture, reducing the flickering risk of the display picture, and improving the display effect and display quality of the display panel.

In some implementations, the compensation signal is determined according to a standard high-frequency refresh rate and a standard low-frequency refresh rate. The standard high-frequency refresh rate is greater than or equal to the preset high-frequency refresh rate, and the standard low-frequency refresh rate is less than the preset low-frequency refresh rate. Here, the first frequency difference is less than a second frequency difference, the first frequency difference is the frequency difference between the first refresh rate and the second refresh rate, and the second frequency difference is the frequency difference between the standard high-frequency refresh rate and the standard low-frequency refresh rate.

Exemplarily, the standard low-frequency refresh rate and the standard high-frequency refresh rate can be determined according to the switchable refresh rates of the display panel. Here, the standard low-frequency refresh rate and the standard high-frequency refresh rate can be determined according to the lowest and highest switchable refresh rates of the display panel. For example, for a display panel with switchable refresh rates of 480Hz or higher, 120Hz, 60Hz, 20Hz, 10Hz, and 1Hz, the standard low-frequency refresh rate can be 1Hz or 10Hz, and the standard high-frequency refresh rate can be 120Hz, 480Hz or higher. For a display panel with switchable refresh rates of 480Hz or higher, 120Hz, 90Hz, 60Hz, 20Hz, and 10Hz, the standard low-frequency refresh rate can be 10Hz, and the standard high-frequency refresh rate can be 90Hz, 120Hz, 480Hz or higher.

It should be noted that for a display panel in which the first frequency difference less than the second frequency difference, the use of the compensation signal determined according to the second frequency difference to compensate the brightness of the first frame f2 to be displayed will cause an overcompensation problem for the first frame f2 to be displayed.

In the display panel provided by the embodiments of the present disclosure, in the case where the first frequency difference is less than the second frequency difference, an inserted frame f0 is provided between the current frame f1 and the first frame f2 to be displayed, and further brightness compensation is performed on the first frame f2 to be displayed through the compensation signal, which can avoid the problem of display picture flickering caused by the brightness reduction of the first frame f2 to be displayed in the refresh rate switching process of the display picture, thereby improving the brightness uniformity and stability of the display picture, and enhancing the display effect and display performance of the display panel.

In some implementations, the refresh rate of the inserted frame f0 is equal to the standard high-frequency refresh rate.

Exemplarily, for a display panel with switchable refresh rates of 480Hz or higher, 120Hz, 60Hz, 20Hz, 10Hz, and 1Hz, the standard high-frequency refresh rate can be 120Hz, 480Hz or higher, and the refresh rate of the inserted frame f0 can be 120Hz, 480Hz or higher. For a display panel with switchable refresh rates of 480Hz or higher, 120Hz, 90Hz, 60Hz, 20Hz, and 10Hz, the standard high-frequency refresh rate can be 90Hz, 120Hz, 480Hz or higher, and the refresh rate of the inserted frame f0 can be 90Hz, 120Hz, 480Hz or higher.

In the display panel provided by the embodiments of the present disclosure, by setting the refresh rate of the inserted frame f0 to be equal to the standard high-frequency refresh rate, the frequency difference between the inserted frame f0 and the first frame f2 to be displayed can be further increased, making the frequency difference between the inserted frame f0 and the first frame f2 to be displayed closer to the second frequency difference. Thus, the compensation effect of the compensation signal on the first frame f2 to be displayed can be enhanced, the brightness uniformity and stability of the display picture can be further improved, the flickering problem of the display picture can be suppressed, and the display effect and display performance of the display panel can be improved.

In some implementations, the compensation signal is configured to adjust at least one of bias voltage and reference voltage of the pixel circuit.

As shown in FIG. 2, in the related display panel, for high-frequency and low-frequency display pictures with different refresh rates, the threshold voltage Vth of the driving transistor is different during the display process. Therefore, in the process of the display picture being switched from a high-frequency display picture to a low-frequency display picture, the threshold voltage Vth of the driving transistor may change, which will cause a negative bias of the driving transistor, and in turn lead to a decrease in the brightness of the low-frequency first frame of display picture, resulting in a dip in the brightness data graph shown in FIG. 2.

It should be noted that adjusting the bias voltage can adjust the source voltage of the driving transistor, so that the gate-source voltage of the driving transistor can be reduced to weaken the degree of the negative bias of the driving transistor, and in turn the effect of suppressing the negative bias of the driving transistor can be achieved, the brightness decrease amplitude of the low-frequency first frame of display picture can be reduced, the display brightness of the low-frequency first frame of display picture can be improved, and the dip in the brightness data graph shown in FIG. 2 can be repaired.

It should be noted that adjusting the reference voltage can adjust the anode voltage of the light-emitting element. It should be noted that although adjusting the bias voltage can weaken the negative bias of the driving transistor when displaying the low-frequency first frame of picture, there is still a brightness difference between the display brightness of the low-frequency first frame of picture after being compensated through the bias voltage and the steady-state brightness. Therefore, by adjusting the reference voltage, it is possible to make the reference voltage and the drain voltage of the driving transistor jointly supply power to the light-emitting element to further perform brightness compensation on the low-frequency first frame of picture, so that the steady-state brightness of the low-frequency display picture can reach the target brightness required for the steady state, improving the accuracy of the display picture, and enhancing the display effect and display performance of the display panel.

In the display panel provided by the embodiments of the present disclosure, by adjusting the bias voltage and the reference voltage of the pixel circuit through the compensation signal, the negative bias of the driving transistor in the pixel circuit can be suppressed, the display brightness of the frame picture driven by the compensation signal can be improved, and the steady-state brightness of the display picture can be compensated, improving the accuracy of the display brightness of the frame picture after switching. Therefore, in the case where the inserted frame f0 is switched to the first frame f2 to be displayed, the flickering risk of the display picture can be reduced, the brightness uniformity and stability of the display picture can be improved, and the display effect and display performance of the display panel can be improved.

In some implementations, in the case where the display panel displays the inserted frame f0, the bias voltage of the pixel circuit is a first bias voltage, and in the case where the display panel displays the first frame f2 to be displayed, the bias voltage of the pixel circuit is a second bias voltage, where the first bias voltage is greater than a second bias voltage.

As shown in FIGS. 3, 6-8, the first bias voltage is DVHA, and the second bias voltage is DVHC.

It should be noted that in the process of the inserted frame f0 being switched to the first frame f2 to be displayed, the display picture is switched from the high-frequency inserted frame f0 to a low-frequency display picture, which may cause a decrease in the brightness of the first frame f2 to be displayed of the low-frequency first frame of picture. Therefore, by reducing the bias voltage, the source voltage of the driving transistor can be reduced, which can reduce the gate-source voltage of the driving transistor and suppress the negative bias caused by the change in the threshold voltage of the driving transistor, which can further improve the display brightness of the first frame f2 to be displayed and reduce the brightness difference between the display brightness of the first frame f2 to be displayed and the steady-state brightness.

In the display panel provided by the embodiments of the present disclosure, by setting the first bias voltage to be greater than the second bias voltage, the negative bias of the driving transistor in the pixel circuit can be suppressed, and further the display brightness of the frame picture driven by the compensation signal can be improved. Therefore, in the case where the inserted frame f0 is switched to the first frame f2 to be displayed, the flickering risk of the display picture can be reduced, the brightness uniformity and stability of the display picture can be improved, and the display effect and display performance of the display panel can be improved.

In some implementations, in the case where the display panel displays the inserted frame f0, the reference voltage of the pixel circuit is a first reference voltage, and in the case where the display panel displays the first frame f2 to be displayed, the reference voltage of the pixel circuit is a second reference voltage, where the first reference voltage is less than the second reference voltage.

As shown in FIGS. 3, 6-8, the first reference voltage is VarA, and the second reference voltage is VarC.

It should be noted that in the process of the inserted frame f0 being switched to the first frame f2 to be displayed, the display picture is switched from the high-frequency inserted frame f0 to a low-frequency display picture, which may cause a decrease in the brightness of the first frame f2 to be displayed of the low-frequency first frame of picture. Therefore, by increasing the reference voltage, the anode voltage of the light-emitting element can be compensated to improve the light-emitting brightness of the light-emitting element, which can improve the display brightness of the display picture and reduces the brightness difference between the display brightness of the first frame f2 to be displayed and the steady-state brightness. In addition, in the case where the brightness of the first frame f2 to be displayed is adjusted by both the bias voltage and the reference voltage, the reference voltage can further compensate for the brightness adjustment effect of the bias voltage, so that the brightness difference between the display brightness of the first frame f2 to be displayed and the steady-state brightness of the display picture is further reduced, and the flickering problem of the display picture is further improved.

In the display panel provided by the embodiments of the present disclosure, by setting the first reference voltage to be less than the second reference voltage, the anode voltage of the light-emitting element can be compensated. The display brightness of the display picture is improved by increasing the anode voltage of the light-emitting element, so that in the case where the inserted frame f0 is switched to the first frame f2 to be displayed, the flickering risk of the display picture can be reduced, the brightness uniformity and stability of the display picture can be improved, and the display effect and display performance of the display panel can be improved.

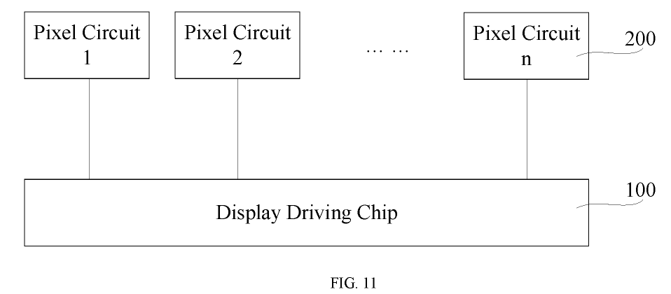

FIG. 11 is a schematic structural diagram of a display panel provided by an embodiment of the present disclosure. As shown in FIG. 11, in a second aspect of the embodiments of the present disclosure, the display panel is provided. The display panel includes a display driving chip 100 and a pixel circuit 200. The display driving chip 100 is used to provide a driving signal to the pixel circuit 200. The display driving chip 100 is configured to: obtain a first refresh rate at which the display panel displays a current frame f1 and a second refresh rate at which the display panel displays the first frame f2 to be displayed, where display time of the current frame f1 is earlier than display time of the first frame f2 to be displayed; and provide, in the case where the first refresh rate and the second refresh rate are not equal and both the first refresh rate and the second refresh rate are less than a preset low-frequency refresh rate, the driving signal to the pixel circuit 200, so that the pixel circuit 200 drives a display picture to display an inserted frame f0 according to the driving signal, where display time of the inserted frame f0 is between the display time of the current frame f1 and the display time of the first frame f2 to be displayed, and a refresh rate of the inserted frame f0 is greater than or equal to a preset high-frequency refresh rate.

Exemplarily, the display panel may include a plurality of pixel circuits 200, and the pixel circuits 200 are configured to drive display pixels to light up. Here, each of the pixel circuits 200 can include an 8T1C pixel circuit.

In the display panel provided by the embodiments of the present disclosure, in the case where the first refresh rate of the current frame f1 and the second refresh rate of the first frame f2 to be displayed are not equal and both the first refresh rate and the second refresh rate are less than the preset low-frequency refresh rate, the display driving chip 100 drives the pixel circuit 200 to insert the inserted frame f0 with the refresh rate greater than or equal to the preset high-frequency refresh rate between the current frame f1 and the first frame f2 to be displayed where the preset high-frequency refresh rate is greater than the preset low-frequency refresh rate. By inserting a high-frequency inserted frame f0 between two frames of low-frequency pictures that need to be mutually switched, the difference in refresh rate between the first frame f2 to be displayed and the inserted frame f0 serving as a previous frame can be increased, which can further cause the difference in refresh rate between the first frame f2 to be displayed and the inserted frame f0 to be close to the preset difference in refresh rate corresponding to the preset compensation value for the low-frequency first frame of the display panel 1000. Therefore, when using the same compensation signal for brightness compensation in the mutual switching of display pictures with different refresh rates, it can be avoided that the compensation signal for switching directly from a high frequency to a low frequency is used in the low-frequency mutual switching process, reducing the risk of overcompensation in the brightness compensation process, avoiding the picture of the first frame to be displayed after switching from flickering, improving the stability of the display picture, and improving the display effect and display quality of the display panel 1000.

In some implementations, the pixel circuit 200 includes: a driving transistor configured to generate a driving current; a switching transistor configured to transmit a data signal to a source of the driving transistor; a compensation transistor configured to perform a diode connection on the driving transistor; a storage capacitor configured to store the data signal transmitted through the switching transistor and the diode-connected driving transistor; a first initialization transistor configured to provide an initialization voltage to the storage capacitor and a gate of the driving transistor in response to an initialization signal; a first light-emitting control transistor configured to transmit a power supply voltage to the source of the driving transistor in response to a light-emitting signal; a second light-emitting control transistor configured to connect a drain of the driving transistor to a light-emitting element in response to a light-emitting control signal; and the light-emitting element configured to emit light based on the driving current. Here, at least one of the driving transistor, the switching transistor, the compensation transistor, the first initialization transistor, the first light-emitting control transistor, and the second light-emitting control transistor is implemented by an N-type metal-oxide-semiconductor transistor.

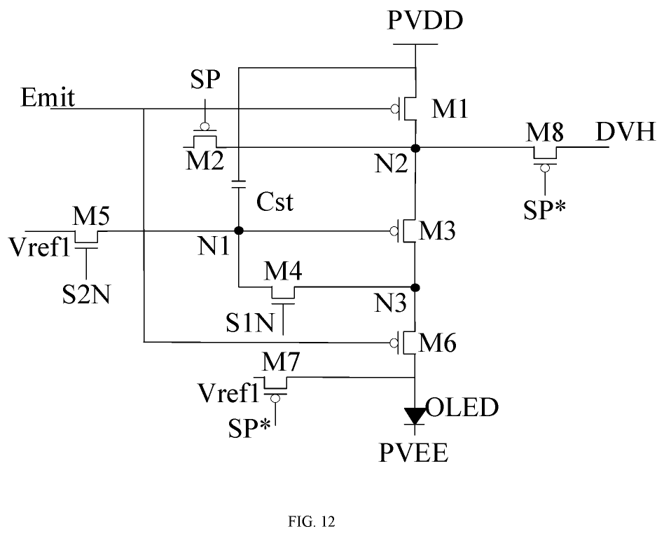

FIG. 12 is a schematic structural diagram of a pixel circuit of a display panel provided by an embodiment of the present disclosure. As shown in FIG. 12, the pixel circuit 200 can be an 8T1C pixel circuit, and in particular includes: a first transistor M1, a second transistor M2, a third transistor M3, a fourth transistor M4, a fifth transistor M5, a sixth transistor M6, a seventh transistor M7, an eighth transistor M8, a light-emitting element OLED, and a storage capacitor Cst. Here, the driving transistor is the third transistor M3, the switching transistor is the second transistor M2, the compensation transistor is the fourth transistor M4, the first initialization transistor is the fifth transistor M5, the first light-emitting control transistor is the first transistor M1, and the second light-emitting control transistor is the sixth transistor M6.

Exemplarily, all the transistors in the pixel circuit 200 can be implemented by N-type metal-oxide-semiconductor transistors or P-type metal-oxide-semiconductor transistors, which is not specifically limited here.

As shown in FIG. 12, one end of the storage capacitor Cst is connected to a first power supply voltage PVDD, and the other end of the storage capacitor Cst is connected between a gate terminal of the third transistor M3 and a second terminal of the fifth transistor M5. An anode of the light-emitting element OLED is electrically connected to a second terminal of the sixth transistor M6, and a cathode of the light-emitting element OLED is connected to a second power supply voltage PVEE. A first terminal of the first transistor M1 is connected to the first power supply voltage PVDD, a gate terminal of the first transistor M1 is connected to a lighting-up signal Emit, and a second terminal of the first transistor M1 is electrically connected to a first terminal of the third transistor M3. A first terminal of the second transistor M2 is connected to a data signal Vdata, a gate terminal of the second transistor M2 is connected to a scan signal SP, and a second terminal of the second transistor M2 is connected between the second terminal of the first transistor M1 and the first terminal of the third transistor M3. A gate terminal of the third transistor M3 is electrically connected to the second terminal of the fifth transistor M5, and a second terminal of the third transistor M3 is electrically connected to a first terminal of the sixth transistor M6. A first terminal of the fourth transistor M4 is electrically connected to the other end of the storage capacitor Cst, a gate terminal of the fourth transistor M4 is connected to a scan signal S2N, and a second terminal of the fourth transistor M4 is connected between the second terminal of the third transistor M3 and the sixth transistor M6. A first terminal of the fifth transistor M5 is connected to a first reference signal Vref1, a gate terminal of the fifth transistor M5 is connected to a scan signal S1N, and the second terminal of the fifth transistor M5 is connected between the other end of the storage capacitor Cst and the first terminal of the fourth transistor M4. The first terminal of the sixth transistor M6 is electrically connected to the second terminal of the third transistor M3, a gate terminal of the sixth transistor M6 is connected to the lighting-up signal Emit, and the second terminal of the sixth transistor M6 is connected to the anode of the light-emitting element OLED. A first terminal of the seventh transistor M7 is connected to a second reference signal Vref2, a gate terminal of the seventh transistor M7 is connected to a scan signal SP*, and a second terminal of the seventh transistor M7 is connected between the second terminal of the sixth transistor M6 and the anode of the light-emitting element OLED. A first terminal of the eighth transistor M8 is connected to a bias voltage signal DVH, a gate terminal of the eighth transistor M8 is connected to the scan signal SP*, and a second terminal of the eighth transistor M8 is connected between the second terminal of the first transistor M1 and the first terminal of the third transistor M3.

During the driving process of the pixel circuit 200 as shown in FIG. 12, the scan signal S1N is configured to control the on and off of the fifth transistor M5. When the fifth transistor M5 is turned on, the fifth transistor M5 is configured to write the first reference signal Vref1 to the gate terminal of the third transistor M3 to reset a first node N1. The scan signal S2N is configured to control the on and off of the fourth transistor M4. When the fourth transistor M4 is turned on, the fourth transistor M4 is configured to perform threshold voltage compensation on the third transistor M3. The scan signal SP is configured to control the on and off of the second transistor M2. When the second transistor M2 is turned on, the data signal Vdata is written to the first terminal of the third transistor M3. The scan signal SP is configured to control the on and off of the seventh transistor M7 and the eighth transistor M8. When the seventh transistor M7 is turned on, the second reference signal Vref2 is written to the anode of the light-emitting element OLED to reset an anode voltage of the light-emitting element OLED. When the eighth transistor M8 is turned on, the bias voltage signal DVH is written to the eighth transistor M8 to perform bias adjustment on a second node N2. The lighting-up signal Emit is configured to control the on and off of the first transistor M1 and the sixth transistor M6. When the first transistor M1 and the sixth transistor M6 are turned on, the first power supply voltage PVDD is written to the anode of the light-emitting element OLED to make the light-emitting element OLED emit light.

It should be noted that in the pixel circuit 200 as shown in FIG. 12, in a bias adjustment stage, the fourth transistor M4 and the eighth transistor M8 are turned on, the bias voltage signal DVH is transmitted to the third transistor M3 through the eighth transistor M8 and to the gate terminal of the third transistor M3 through the fourth transistor M4, so that bias adjustment can be achieved for the first node N1, the second node N2, and a third node N3. In a initialization stage, the fifth transistor M5 is turned on, then the fourth transistor M4 is turned on, the first reference signal Vref1 adjusts the gate terminal of the third transistor M3 through the fifth transistor M5 and adjusts the third node N3 through the fifth transistor M5 and the fourth transistor M4. In a data writing stage, the second transistor M2 and the fourth transistor M4 are turned on, the data signal Vdata is written to the gate terminal of the third transistor M3 through the second transistor M2 and the fourth transistor M4, and at the same time, the eighth transistor M8 can perform bias adjustment on the second node N2.

In the display panel provided by the embodiments of the present disclosure, by configuring at least one of the transistor in the pixel circuit 200 as an N-type metal-oxide-semiconductor transistor, a leakage current of the pixel circuit 200 can be reduced, the display power consumption of the display panel can be lowered, the electric leakage problem of the display panel in the process of low-frequency display can be further improved, the accuracy and stability of the display picture can be improved, and the display effect and display quality of the display panel can be improved.

In some implementations, the first initialization transistor and the compensation transistor are implemented by N-type metal-oxide-semiconductor transistors.

Exemplarily, the remaining transistors in the pixel circuit 200 can be implemented by P-type metal-oxide-semiconductor transistors.

In the display panel provided by the embodiments of the present disclosure, by configuring the first initialization transistor and the compensation transistor in the pixel circuit 200 as N-type metal-oxide-semiconductor transistors, the first initialization transistor and the compensation transistor can be turned on under the control of a high-level signal, further improving the display effect and display quality of the display panel.

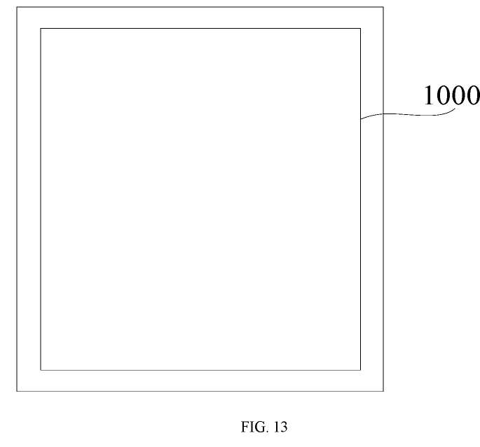

FIG. 13 is a schematic structural diagram of a display apparatus provided by an embodiment of the present disclosure. As shown in FIG. 13, in a third aspect of the embodiments of the present disclosure, the display apparatus is provided. The display apparatus includes any display panel 1000 as described in the above-mentioned first aspect.

In the display apparatus provided by the embodiments of the present disclosure, in the case where the first refresh rate of the current frame f1 and the second refresh rate of the first frame f2 to be displayed are not equal and both the first refresh rate and the second refresh rate are less than the preset low-frequency refresh rate, the inserted frame f0 with the refresh rate greater than or equal to the preset high-frequency refresh rate is inserted between the current frame f1 and the first frame f2 to be displayed, where the preset high-frequency refresh rate is greater than the preset low-frequency refresh rate. By inserting a high-frequency inserted frame f0 between two frames of low-frequency pictures that need to be mutually switched, the difference in refresh rate between the first frame f2 to be displayed and the inserted frame f0 serving as a previous frame can be increased, which can further cause the difference in refresh rate between the first frame f2 to be displayed and the inserted frame f0 to be close to the preset difference in refresh rate corresponding to the preset compensation value for the low-frequency first frame of the display panel 1000. Therefore, when using the same compensation signal for brightness compensation in the mutual switching of display pictures with different refresh rates, it can be avoided that the compensation signal for switching directly from a high frequency to a low frequency is used in the low-frequency mutual switching process, reducing the risk of overcompensation in the brightness compensation process, avoiding the picture of the first frame to be displayed after switching from flickering, improving the stability of the display picture, and improving the display effect and display quality of the display panel 1000.

In the description of this specification, description referring to the terms “some embodiments”, “other embodiments”, “ideal embodiments” and the like means that specific features, structures, materials or characteristics described in conjunction with the embodiment or example are included in at least one embodiment or example of the present disclosure. In this specification, the illustrative description of the above-mentioned terms does not necessarily refer to the same embodiment or example.

The technical features of the above-described embodiments can be combined arbitrarily. For the sake of a concise description, not all possible combinations of the technical features of the above-described embodiments have been described. However, as long as there is no contradiction in the combination of these technical features, it should be considered as within the scope recorded in this specification.

The above-described embodiments only express several implementations of the present disclosure. The description is relatively specific and detailed, but it should not be construed as a limitation on the scope of the patent disclosure. It should be noted that for those of ordinary skill in the art, without departing from the concept of the present disclosure, several modifications and improvements can be made, and these all belong to the protection scope of the present disclosure. Therefore, the protection scope of the patent of the present disclosure shall be subject to the appended claims.

What is claimed is:

1. A display panel, wherein a picture display process of the display panel comprises a current frame and a first frame to be displayed, wherein display time of the current frame is earlier than display time of the first frame to be displayed, a refresh rate of the current frame is a first refresh rate, and a refresh rate of the first frame to be displayed is a second refresh rate;
in a case where the first refresh rate and the second refresh rate are not equal and both the first refresh rate and the second refresh rate are less than a preset low-frequency refresh rate, the picture display process of the display panel further comprises an inserted frame, display time of the inserted frame is between the display time of the current frame and the display time of the first frame to be displayed, and a refresh rate of the inserted frame is greater than or equal to a preset high-frequency refresh rate; and
wherein the preset high-frequency refresh rate is greater than the preset low-frequency refresh rate.

2. The display panel according to claim 1, wherein one inserted frame is provided.

3. The display panel according to claim 1, wherein a plurality of inserted frames are provided.

4. The display panel according to claim 3, wherein refresh rates of at least two of the plurality of inserted frames are equal.

5. The display panel according to claim 3, wherein the plurality of inserted frames are periodically inserted between the current frame and the first frame to be displayed.

6. The display panel according to claim 1, wherein the refresh rate of the inserted frame is greater than or equal to 90Hz.

7. The display panel according to claim 3, wherein a number of the inserted frames is negatively correlated with the refresh rate of the inserted frames.

8. The display panel according to claim 1, wherein a frequency difference between the first refresh rate and the second refresh rate is a first frequency difference, wherein the first frequency difference is less than or equal to a preset frequency difference threshold.

9. The display panel according to claim 1, further comprising:
a display driving chip configured to:
in a case where the refresh rate of the inserted frame is not equal to the second refresh rate of the first frame to be displayed, provide a compensation signal to a pixel circuit, so that the pixel circuit drives a display picture to display the first frame to be displayed according to compensation signal.

10. The display panel according to claim 9, wherein the compensation signal is determined according to a standard high-frequency refresh rate and a standard low-frequency refresh rate, the standard high-frequency refresh rate is greater than or equal to the preset high-frequency refresh rate, and the standard low-frequency refresh rate is less than the preset low-frequency refresh rate; and
wherein a first frequency difference is less than a second frequency difference, the first frequency difference is a frequency difference between the first refresh rate and the second refresh rate, and the second frequency difference is a frequency difference between the standard high-frequency refresh rate and the standard low-frequency refresh rate.

11. The display panel according to claim 10, wherein the refresh rate of the inserted frame is equal to the standard high-frequency refresh rate.

12. The display panel according to claim 9, wherein the compensation signal is configured to adjust at least one of a bias voltage and a reference voltage of the pixel circuit.

13. The display panel according to claim 12, wherein in a case where the display panel displays the inserted frame, the bias voltage of the pixel circuit is a first bias voltage, and the reference voltage of the pixel circuit is a first reference voltage; and in a case where the display panel displays the first frame to be displayed, the bias voltage of the pixel circuit is a second bias voltage, and the reference voltage of the pixel circuit is a second reference voltage; and
wherein the first bias voltage is greater than the second bias voltage, and/or the first reference voltage is less than the second reference voltage.

14. The display panel according to claim 1, comprising a display driving chip and a pixel circuit, wherein the pixel circuit comprises:
a driving transistor configured to generate a driving current;
a switching transistor configured to transmit a data signal to a source of the driving transistor;
a compensation transistor configured to perform a diode connection on the driving transistor;
a storage capacitor configured to store the data signal transmitted through the switching transistor and the diode-connected driving transistor;
a first initialization transistor configured to provide an initialization voltage to the storage capacitor and a gate of the driving transistor in response to an initialization signal;
a first light-emitting control transistor configured to transmit a power supply voltage to the source of the driving transistor in response to a light-emitting signal; and
a second light-emitting control transistor configured to connect a drain of the driving transistor to a light-emitting element in response to a light-emitting control signal;
wherein the light- emitting element is configured to emit light based on the driving current, and at least one of the driving transistor, the switching transistor, the compensation transistor, the first initialization transistor, the first light-emitting control transistor, and the second light-emitting control transistor is implemented by an N-type metal-oxide-semiconductor transistor.

15. A display panel, comprising a display driving chip and a pixel circuit,
wherein the display driving chip is used to provide a driving signal to the pixel circuit and is configured to:
obtain a first refresh rate at which the display panel displays a current frame and a second refresh rate at which the display panel displays the first frame to be displayed, wherein display time of the current frame is earlier than display time of the first frame to be displayed; and
provide, in a case where the first refresh rate and the second refresh rate are not equal and both the first refresh rate and the second refresh rate are less than a preset low-frequency refresh rate, the driving signal to the pixel circuit, so that the pixel circuit drives a display picture to display an inserted frame according to the driving signal, wherein display time of the inserted frame is between the display time of the current frame and the display time of the first frame to be displayed, and a refresh rate of the inserted frame is greater than or equal to a preset high-frequency refresh rate.

16. The display panel according to claim 15, wherein the pixel circuit comprises:
a driving transistor configured to generate a driving current;
a switching transistor configured to transmit a data signal to a source of the driving transistor;
a compensation transistor configured to perform a diode connection on the driving transistor;
a storage capacitor configured to store the data signal transmitted through the switching transistor and the diode-connected driving transistor;
a first initialization transistor configured to provide an initialization voltage to the storage capacitor and a gate of the driving transistor in response to an initialization signal;
a first light-emitting control transistor configured to transmit a power supply voltage to the source of the driving transistor in response to a light-emitting signal; and
a second light-emitting control transistor configured to connect a drain of the driving transistor to a light-emitting element in response to a light-emitting control signal;
wherein the light- emitting element is configured to emit light based on the driving current, and at least one of the driving transistor, the switching transistor, the compensation transistor, the first initialization transistor, the first light-emitting control transistor, and the second light-emitting control transistor is implemented by an N-type metal-oxide-semiconductor transistor.

17. The display panel according to claim 16, wherein the first initialization transistor and the compensation transistor are implemented by N-type metal-oxide-semiconductor transistors.

18. A display apparatus, comprising a display panel, wherein a picture display process of the display panel comprises a current frame and a first frame to be displayed, wherein display time of the current frame is earlier than display time of the first frame to be displayed, a refresh rate of the current frame is a first refresh rate, and a refresh rate of the first frame to be displayed is a second refresh rate;
in a case where the first refresh rate and the second refresh rate are not equal and both the first refresh rate and the second refresh rate are less than a preset low-frequency refresh rate, the picture display process of the display panel further comprises an inserted frame, display time of the inserted frame is between the display time of the current frame and the display time of the first frame to be displayed , and a refresh rate of the inserted frame is greater than or equal to a preset high-frequency refresh rate; and
wherein the preset high-frequency refresh rate is greater than the preset low-frequency refresh rate.
